(19) United States
(12) Patent Application Publication
(10) Pub. No.: US 2012/0274748 A1
(43) Pub. Date: Nov. 1, 2012

(54) Stereoscopic Image Display Device and Method for Driving the Same

(75) Inventors: Kwangjo Hwang, Anyang-si (KR); Hyeonho Son, Goyang-si (KR); Seok Kim, Paju-si (KR)

(73) Assignee: LG DISPLAY CO., LTD., Seoul (KR)

(21) Appl. No.: 13/455,823

(22) Filed: Apr. 25, 2012

(30) Foreign Application Priority Data
Apr. 28, 2011 (KR) 10-2011-0040013

(51) Int. Cl. H04N 13/04

(52) U.S. Cl. 348/51; 348/E13.026

(57) ABSTRACT

A stereoscopic image display device and a method for driving the stereoscopic image display device. The stereoscopic image display device divides pixels of a display panel into first sub-divided pixels and second sub-divided pixels. The second sub-divided pixels are controlled to function as an active black stripe during a 3D mode to enhance the quality of a 3D mode. However, the second sub-divided pixels are controlled to display a 2D image during a 2D mode to prevent the reduction of luminance in the 2D mode.

### CROSS-REFERENCE TO RELATED APPLICATIONS

This application claims priority under 35 U.S.C. 119(a) of Korean Patent Application No. 10-2011-0040013, filed on Apr. 28, 2011, which is hereby incorporated by reference in its entirety.

### BACKGROUND

1. Technical Field

The embodiments disclosed herein generally relate to a stereoscopic image display device and a method, which divides pixels of a display panel into first sub-divided pixels and second sub-divided pixels and controls the second sub-divided pixels as an active black stripe.

2. Discussion of the Related Art

Techniques for implementing a stereoscopic image display device to display three-dimensional (3D) images are classified as either a stereoscopic technique or an autostereoscopic technique. Generally, a stereoscopic technique creates or enhances the illusion of depth in an image by presenting two offset images separately to the left eye and the right eye of the user viewing the 3D image and requires the use of glasses to view the 3D image. Specifically, the stereoscopic technique, uses a binocular parallax image between a user's left and right-eye and may include a glasses type method to view the 3D image. A non-glasses type method, otherwise known as an autostereoscopic technique, may also be used to view the 3D image and does not require the use of glasses to view the 3D image.

The glasses method is classified into a patterned retarder method (hereinafter, referred to as a PR type) and a shutter glass method. In the PR type, a 3D image is implemented by using polarization glasses to view a binocular parallax image displayed on a direct view-based display device (or on a projector) by changing a polarization direction. In the shutter glass method, a 3D image is implemented by using liquid crystal shutter glasses to view a binocular parallax image displayed on a direct view-based display device (or on a projector) in a time division manner.

In the non-glasses method, a 3D image is implemented by installing an optical plate, such as a parallax barrier or a lenticular lens. The optical plate separates an optical axis of the left and right parallax image and prevents the need for glasses to view the stereoscopic image.

FIG. 1 illustrates a conventional PR type stereoscopic image display device. The PR type stereoscopic image display device provides a 3D image using the polarization characteristic of a patterned retarder PR disposed on a display panel DIS and the polarization characteristic of polarized glasses PG that the user wears to view the 3D image. The PR type stereoscopic image display device displays left-eye images (i.e., images viewed by the left eye) on odd-numbered lines of the display panel DIS and displays right-eye images (i.e., images viewed by the right eye) on even-numbered lines of the display panel DIS. The left-eye images are converted into left-circularly polarized light by the patterned retarder PR. The right-eye images are similarly converted into right-circularly polarized light by the patterned retarder PR. A left-eye polarizing filter of the polarized glasses PG passes through only the left-circularly polarized light to the left eye of the user and intercepts/filters the right-circularly polarized light so that the right-circularly polarized light is not received by the left eye of the user. Similarly, a right-eye polarizing filter of the polarized glasses PG passes through only the right-circularly polarized light to the right eye of the user and intercepts/filters the left-circularly polarized light so that the left-circularly polarized light is not received by the right eye of the user. Therefore, the user views only the left-eye images through a user's left-eye and views only the right-eye images through a user's right-eye.

The left-eye images should be input only to the user's left-eye and the right-eye images should only be input to the user's right-eye in order for the user to view a high quality 3D image. However, the left-eye images and the right-eye images are simultaneously input to the both the user's left-eye or right-eye when the user views the 3D image at an angle greater than a vertical viewing angle thereby resulting in crosstalk. Thus, the user is bound to perceive 3D crosstalk by which the left-eye images and the right-eye images are seen to overlap with each other.

FIG. 2 illustrates a PR type stereoscopic image display device for widening a vertical viewing angle of a PR type stereoscopic image display by forming black stripes BS on a patterned retarder PR as described in Japanese patent application publication No. 2002-185983. The vertical viewing angle α depends on a size of a black matrix BM formed in the display panel DIS, a size of the black stripe BS formed on the patterned retarder PR, and a distance S between the display panel DIS and the patterned retarder PR when the user views the 3D image at a position away from the patterned retarder PR by the predetermined distance D. A wider vertical viewing angle α requires larger sizes of each of the black matrix and the black stripe. A narrower vertical viewing angle a requires a smaller distance S between the display panel DIS and the patterned retarder PR.

While the black stripes BS on the patterned retarder PR contribute to an increase in the vertical viewing angle α of the PR type stereoscopic image display device, the interaction of the black matrix BM of the display panel DIS generates an interference pattern such as a Moire pattern. In this instance, when the PR type stereoscopic image display device displays a 2D image, visibility of the 2D image is greatly reduced because of the Moire pattern. Furthermore, luminance of the 2D image displayed on the PR type stereoscopic image display device is greatly reduced because of the black stripes BS of the patterned retarder PR. The luminance is reduced because some of the pixels of the display panel DIS are covered by the black stripes BS of the patterned retarder PR thereby blocking the luminance of these pixels. Also, if there is a misalignment between the display panel DIS and the patterned retarder PR, the black stripes BS do not function effectively. Therefore, it is necessary for the black stripes BS to be aligned with the display panel DIS with the patterned retarder PR.

### SUMMARY

The embodiments disclosed herein relate to a stereoscopic image display device and a method for driving the stereoscopic image display device. Generally, the stereoscopic image display device divides pixels of a display panel into first sub-divided pixels and second sub-divided pixels. The second sub-divided pixels are controlled to function as an active black stripe even though a frequency of a gate driver is not increased. Implementing black stripes using the pixels of the display panel when displaying 3D images decreases crosstalk when displaying the 3D images and also prevents the reduction of the luminance when displaying 2D images because the black stripes are not implemented when displaying the 2D images. Thus, the display quality of 2D images and 3D images is increased.

The features and advantages described in this summary and the following detailed description are not intended to be limiting. Many additional features and advantages will be apparent to one of ordinary skill in the art in view of the drawings, specification and claims.

### BRIEF DESCRIPTION OF THE DRAWINGS

FIG. 1 illustrates a conventional PR type stereoscopic image display device.

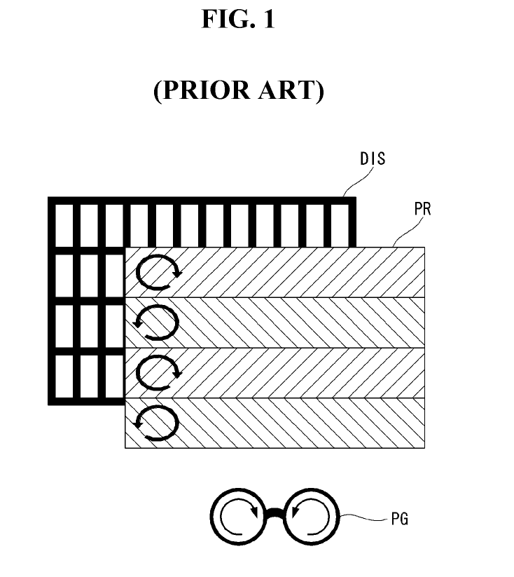

FIG. 2 illustrates a conventional PR type stereoscopic image display device including black stripes.

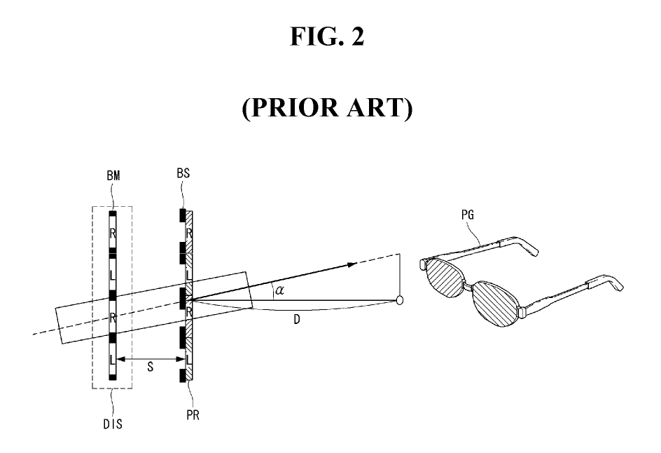

FIG. 3 illustrates a block diagram of a stereoscopic image display device according to one embodiment.

FIG. 4 illustrates an exploded perspective view of the stereoscopic image display device of FIG. 3 according to one embodiment.

FIG. 5 illustrates a circuit diagram showing a plurality of pixels of a display panel according to one embodiment.

FIG. 6 illustrates a waveform diagram of waveforms of the stereoscopic image display device in a 3D mode according to one embodiment.

FIG. 7 illustrates a display image of a pixel in a 3D mode according to one embodiment.

FIG. 8 illustrates a waveform diagram of waveforms of the stereoscopic image display device in a 2D mode according to one embodiment.

FIG. 9 illustrates a display image of a pixel in a 2D mode according to one embodiment.

The drawings depict, and the detail description describes, various non-limiting embodiments for purposes of illustration only. One skilled in the art will readily recognize from the following discussion that alternative embodiments of the structures and methods illustrated herein may be employed without departing from the principles described herein.

### DETAILED DESCRIPTION

The invention will be described more fully hereinafter with reference to the accompanying drawings, in which example embodiments of the inventions are shown. This invention may, however, be embodied in many different forms and should not be construed as limited to the embodiments set forth herein. Like reference numerals designate like elements throughout the specification. In the following description, if it is decided that the detailed description of known function or configuration related to the invention makes the subject matter of the invention unclear, the detailed description is omitted.

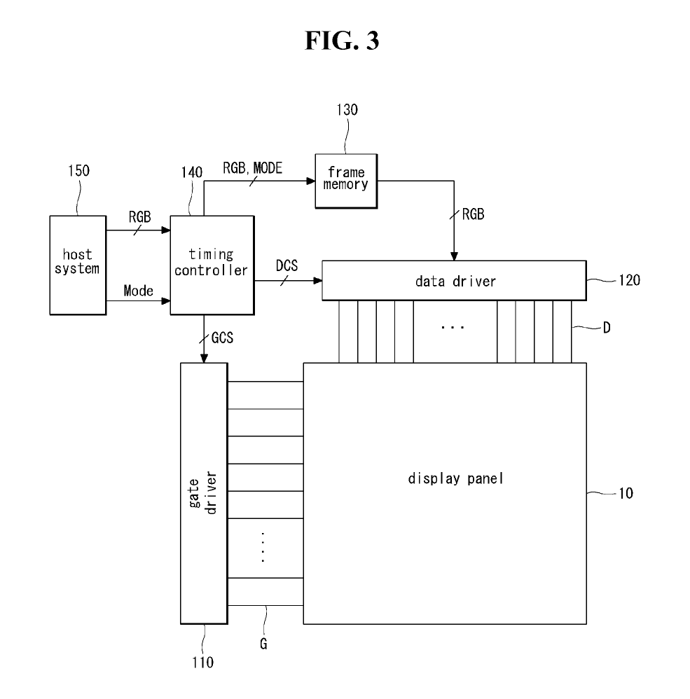

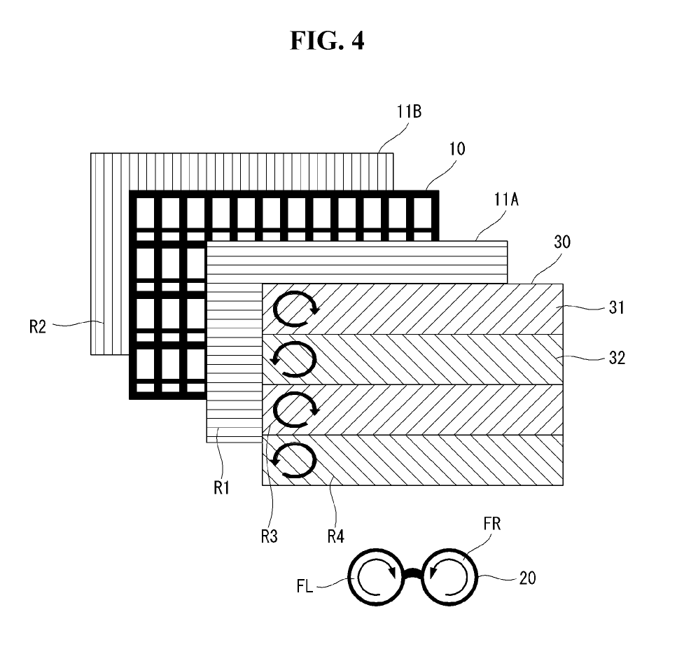

FIG. 3 illustrates a block diagram of a stereoscopic image display device according to one embodiment. FIG. 4 is illustrates an exploded perspective view of the stereoscopic image display device. The stereoscopic image display device according to the embodiment may be implemented as a flat panel display such as a liquid crystal display (LCD), a field emission display (FED), a plasma display panel (PDP) display, or an organic light emitting diode (OLED) display. In the following description, the liquid crystal display is described as an example of the stereoscopic image display device. But, the embodiments described herein are not limited to LCDs.

Referring to FIGS. 3 and 4, the stereoscopic image display device according to the embodiment includes a display panel 10, polarization glasses 20, a gate driver 110, a data driver 120, a frame memory 130, a timing controller 140, and a host system 150. The display panel 10 includes a thin film transistor (TFT) substrate (not shown) and a color filter substrate (not shown). A liquid crystal layer (not shown) is formed between the TFT substrate and the color filter substrate. The display panel 10 includes pixels arranged in a matrix form based on a crossing structure of data lines D and gate lines G (or scan lines) and are formed on TFT substrate. A TFT formed at each of crossings of the data lines D and the gate lines G transfers a data voltage supplied via the data line D to a pixel electrode of the liquid crystal cell in response to a gate pulse supplied through the gate line G. A common voltage is supplied to a common electrode. Each of pixels is driven by an electric field between the pixel electrode and the common electrode.

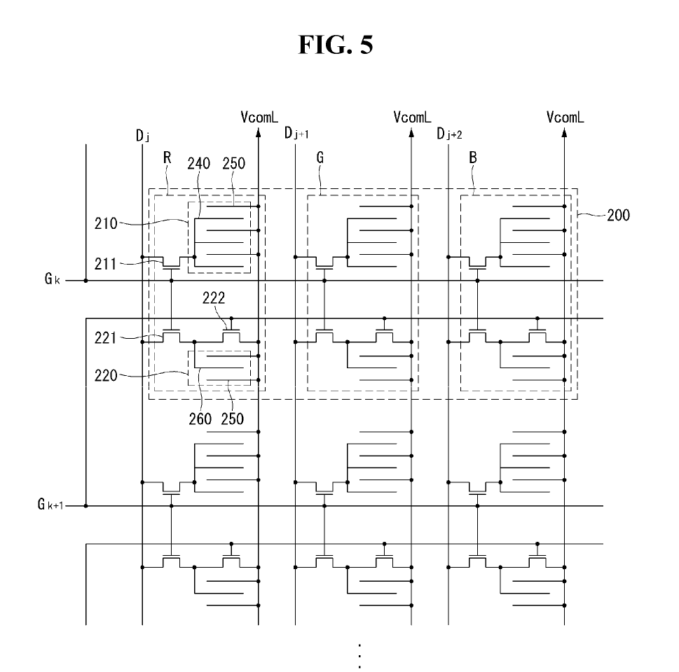

Each of the pixels includes a first to a pₜₕ color sub pixels, wherein p is a natural number greater than 2. For example, each of pixels includes a first to a third color sub pixels. The first color sub pixel may be a red sub pixel, and a second color sub pixel may be a green sub pixel, and a third color sub pixel may be a blue sub pixel according to one embodiment. Each of the sub pixels includes a first sub-divided pixel that displays a 2D image in a 2D mode of the stereoscopic image display device and the first sub-divided pixel also displays a 3D image in a 3D mode. Each of the sub pixels also includes a second sub-divided pixel that displays the 2D image in the 2D mode. However,the second sub-divided pixel displays a black image in order to function as a black stripe in the 3D mode of the stereoscopic image display device. Therefore, the second sub-divided pixel functions as an active black stripe such that pixels that display the 2D image while the stereoscopic display device is in a 2D mode display a black image while the stereoscopic display device is in a 3D mode. The pixels of the display panel 10 according to the embodiment are described in detail with reference to FIG. 5.

A color filter array (not shown) including a black matrix (not shown) and a color filter (not shown) is formed on the color filter substrate. The common electrode is formed on the color filter substrate in a vertical electric field driving manner such as a twisted nematic (TN) mode and a vertical alignment (VA) mode. The common electrode is formed on the TFT substrate along with the pixel electrode in a horizontal electric field driving manner such as an in-plane switching (IPS) mode and a fringe field switching (FFS) mode. The display panel 10 may be implemented in any liquid crystal mode such as the TN, VA, IPS, and FFS modes.

The display panel 10 may be implemented as a transmissive type liquid crystal panel modulating light from a backlight unit (not shown). The backlight unit includes a plurality of light sources, a light guide plate (or a diffusion plate), a plurality of optical sheets, and the like. The backlight unit may be implemented as an edge type backlight unit or a direct type backlight unit. The light sources of the backlight unit may include at least one of a hot cathode fluorescent lamp (HCFL), a cold cathode fluorescent lamp (CCFL), an external electrode fluorescent lamp (EEFL), and a light emitting diode (LED).

A backlight unit driver (not shown) generates a driving current for turning on the light sources of the backlight unit. The backlight unit driver switches on or off the driving current supplied to the light sources under the control of a backlight controller (not shown). The backlight controller may be included in the timing controller 140 according to one embodiment.

Referring to FIG. 4, an upper polarizing plate 11A is attached (i.e., coupled) to the color filter substrate (not shown), and a lower polarizing plate 11B is attached to the TFT substrate (not shown). A first light transmission axis R1 of the upper polarizing plate 11A is perpendicular to a second light transmission axis R2 of the lower polarizing plate 11B. Alignment layers for setting pre-tilt angles of liquid crystals are respectively formed on the TFT substrate and the color filter substrate. A spacer (not shown) is formed between the TFT substrate and the color filter substrate to maintain a cell gap of the liquid crystal layer.

The display panel 10 displays a 2D image on both odd-numbered lines and even-numbered lines of the display panel 10 during the 2D mode of the stereoscopic image display device. In contrast, the display panel 10 displays a left eye image on the odd-numbered lines of the display panel 10 and displays the right eye image on the even-numbered lines during the three3D mode of the stereoscopic image display device. Alternatively, the display panel 10 may display a right eye image on the odd-numbered lines of the display panel 10 and may display the left eye image on the even-numbered lines of the display panel 10 during the 3D mode. The image displayed on the display panel 10 is incident on a patterned retarder 30 disposed on the display panel 10 through the upper polarizing plate 11A.

The patterned retarder 30 includes a plurality of first retarders 31 formed on the odd-numbered lines of the patterned retarder 30 and a plurality of second retarders 32 formed on the even-numbered lines of the patterned retarder 30. The first retarders 31 are located at a position on the patterned retarder 30 that is opposite to the odd-numbered lines of the display panel 10. Similarly, the second retarders 32 are located at a position on the patterned retarder 30 that is opposite to the even-numbered lines of the display panel 10. The first retarders 31 retard a phase of light from the even-numbered lines of the display panel 10 by +λ/4 according to one embodiment, where λ is a wavelength of light. The second retarders 32 retard a phase of the light from the odd-numbered lines of the display panel 10 by −λ/4 according to one embodiment.

A first optical axis R3 of the first retarder 31 is perpendicular to a second optical axis R4 of the second retarder 32. Therefore, the first retarders 31 may convert the light incident from the display panel 10 into a first circularly polarized light (for example, a left circularly polarized light). The second retarders 32 may convert the light incident from the display panel 10 into a second circularly polarized light (for example, a right circularly polarized light).

The polarization glasses 20 shown in FIG. 4 include a left eye polarization filter FL through which the first circularly polarized light passes and a right eye polarization filter FR through which the second circularly polarized light passes. That is, the left eye polarization filter FL can pass through left circularly polarized light, and the right eye polarization filter FR can pass through right circularly polarized light.

In the PR type stereoscopic image display device, the left image displayed on the odd-numbered lines of the display panel 10 is converted into the first circularly polarized light by the first retarders 31 of the patterned retarder 30 in one embodiment. The left eye polarization filter FL passes through the first circularly polarized light, and thus a user views only left image through his/her left eye. Similarly, the right image displayed on the even-numbered lines of the display panel 10 is converted into the second circularly polarized light by the second retarders 32 of the patterned retarder 30. The right eye polarization filter FR passes through the second circularly polarized light, and thus a user views only right image through his/her right eye.

Referring back to FIG. 3, the data driver 120 includes a plurality of source driver integrated circuits (ICs) (not shown). The source driver ICs convert digital video data received from the frame memory 130 into positive or negative polarity voltages and generate positive or negative polarity analog data voltage. The source driver ICs supply the positive and negative polarity analog data voltages that are representative of the digital video data to the data lines D of the display panel 10.

The frame memory 130 receives digital video data RGB and a mode signal MODE from the timing controller 140 and stores the digital video data RGB. The frame memory 130 distinguishes the 2D mode from the 3D mode based on the mode signal MODE. In the 3D mode, the frame memory 130 supplies the digital video data RGB to the data driver 120 in the order in which the digital video data is input into the frame memory 130. In contrast, in the 2D mode the frame memory 130 supplies the digital video data RGB to the data driver 120 in the reverse order in which the digital video data is input into the frame memory 130.

The gate driver 110 sequentially supplies a gate pulse to the gate lines G of the display panel 10 which is synchronized with a data voltage supplied to the data lines D which is under the control of the timing controller 140. The gate driver 110 includes a plurality of gate driver ICs (not shown). Each of the gate driver ICs includes a shift register, a level shifter for converting an output signal of the shift register into a signal having a swing width suitable for a TFT drive of the liquid crystal cell, an output buffer, and the like. In the 3D mode, the gate driver 110 sequentially supplies the gate pulses to the gate lines G in a first direction. In one embodiment, the first direction describes a forward direction. That is, the gate driver 110 supplies the gate pulses to the gate lines G in an ascending order of the position of the gate lines G. For example, consider three gate lines GPₖ₋₁, GPₖ, and GP_{K+1} where gate line GPₖ₋₁ is positioned before gate line GPₖ which is positioned before gate line GP_{K+1}. During the 3D mode, the gate driver 110 supplies gate pulses in an ascending order such that a gate pulse is first supplied to gate line GPₖ₋₁ followed by a gate pulse to gate line GPₖ followed by a gate pulse to gate line GP_{K+1}.

In the 2D mode, the gate driver 110 sequentially supplies the gate pulses to the gate lines G in a second direction that is different from the first direction. In one embodiment, the second direction is a backward direction. Using the example described above with respect to the 3D mode, the gate driver 110 supplies the gate pulses to the gate lines G in a descending order of the position of the gate lines G. For example, during the 2D mode, the gate driver 110 first supplies a gate pulse to the last gate line GP_{K+1} followed by a gate pulse to gate line GPₖ followed by a gate pulse to the first gate line GPₖ₋₁.

The timing controller 140 receives the digital video data RGB, the timing signals, and the mode signal MODE from the host system 150. The timing signals include a vertical synchronization signal, a horizontal synchronization signal, a data enable signal, a dot clock, etc. The timing controller 140 generates a gate control signal GCS for controlling the gate driver 110 and generates a data control signal DCS for controlling the data driver 120 based on the digital video data RGB, the mode signal MODE, timing signals, etc. The timing controller 140 outputs the gate control signal GCS to the gate driver 110. The timing controller 140 outputs the data control signal DCS to the data driver 120. The timing controller 140 also outputs the digital video data RGB and the mode signal MODE to the frame memory 130.

The host system 150 supplies the digital video data RGB to the timing controller 140 through an interface such as a low voltage differential signaling (LVDS) interface and a transition minimized differential signaling (TMDS) interface. Further, the host system 150 supplies the timing signals and a mode signal MODE for distinguishing the 2D mode from the 3D mode to the timing controller 140.

The host system 150 includes a SoC (system on chip) built in a scaler that converts the digital video data RGB received from an external video source device to adapt the resolution of the display panel 10 appropriately. Also, the host system 150 includes a 3D formatter that converts the digital video data RGB according to a 3D format in the 3D mode.

FIG. 5 illustrates a circuit diagram showing a subset of the pixels 200 of the display panel 10. The pixels 200 are arranged in a cell area defined by a crossing of the gate lines G and the data lines D on the TFT substrate of the display panel 10. Common voltage lines VcomL are formed on the TFT substrate. The common voltage lines VcomL are positioned parallel to the data lines D.

According to one embodiment, each of pixels 200 includes a color sub pixel including a red sub pixel R, a green sub pixel G, and a blue sub pixel B. Each of the color sub pixels includes a first sub-divided pixel 210 and a second sub-divided pixel 220. The first sub-divided pixel displays the 2D image in the 2D mode and displays the 3D image in the 3D mode. The second sub-divided pixel displays the 2D image in the 2D mode and displays a black image in the 3D mode. The black image functions as a black stripe in the 3D mode.

The first sub-divided pixel 210 includes a first scan TFT 211 and is driven by an electric field between the first sub-divided pixel electrodes 240 and common electrodes 250. Each of the first sub-divided pixel electrodes 240 is connected to a drain electrode of the first scan TFT 211 and receives the data voltage supplied by the data lines D. Each of the common electrodes 250 is connected to the common voltage line VcomL and receives the common voltage from the common voltage line VcomL. In FIG. 5, the first sub-divided pixel electrodes 240 are parallel to the common electrodes 250 in order to be driven by a horizontal electric field driving manner such as the IPS mode. However, other driving techniques may be used. For example, the vertical electric field driving technique such as the TN mode and the VA mode may be used. However, when using the vertical electric field driving technique, the common electrodes 250 are formed on the color filter substrate.

The first scan TFT 211 supplies a jₜₕ data voltage from a jₜₕ data line Dⱼ to the first sub-divided pixel electrodes 240 in response to a kₜₕ gate pulse supplied by a kₜₕ gate line Gₖ. In one embodiment, j is a natural number greater than or equal to 1 and less than or equal to m, where m is the total number of the data lines and k is a natural number greater than or equal to 1 and less than or equal to n, where n is the total number of the gate lines. Thus, the first sub-divided pixel 210 charges the first sub-divided pixel electrodes 240 with the data voltage from a jₜₕ data line that is coupled to the first sub-divided pixel electrodes 240 through the first scan TFT 211. A gate electrode of the first scan TFT 211 is connected (i.e., coupled) to the kₜₕ gate line Gₖ and a source electrode of the first scan TFT 211 is connected to the jₜₕ data line Dⱼ. The drain electrode of the first scan TFT 211 is connected to the first sub-divided pixel electrodes 240.

The second sub-divided pixel 220 includes a second scan TFT 221 and a third scan TFT 222, and is driven by an electric field between the second sub-divided pixel electrodes 260 and common electrodes 250. Each of the second sub-divided pixel electrodes 260 is connected to a drain electrode of the second scan TFT 221 and receives the data voltage from the drain electrode of the second scan TFT 221. Also, each of the second sub-divided pixel electrodes 260 is connected to a source electrode of the third scan TFT 222 and receives the common voltage. Each of the common electrodes 250 is connected to the common voltage line VcomL and receives the common voltage from the common voltage line VcomL. In FIG. 5, the second sub-divided pixel electrodes 260 are parallel to the common electrodes 250 in order to be driven by a horizontal electric field technique such as IPS mode.

The second scan TFT 221 supplies the jₜₕ data voltage from the jₜₕ data line Dⱼ to the second sub-divided pixel electrodes 260 in response to the kₜₕ gate pulse from the kₜₕ gate line Gₖ. Thus, the second sub-divided pixel 220 charges the second sub-divided pixel electrodes 260 with the data voltage from the jₜₕ data line that is coupled to the second sub-divided pixel electrodes 260 through the second scan TFT 221. A gate electrode of the second scan TFT 221 is connected to the kₜₕ gate line Gₖ and a source electrode of the second scan TFT 221 is connected to the jₜₕ data line Dⱼ. The drain electrode of the second scan TFT 221is connected to the second sub-divided pixel electrodes 260.

The third scan TFT 222 supplies the common voltage from the common voltage line VcomL to the second sub-divided pixel electrodes 260 in response to a (k+1)th gate pulse from a (k+1)th gate line Gₖ₊₁. That is, the third scan TFT 222 supplies the common voltage from the common voltage line VcomL to the second sub-divided pixel electrodes 260 in response to a gate pulse on an adjacent gate line that is positioned after the gate line Gₖ. Thus, the second sub-divided pixel 220 charges the common voltage from the common voltage line VcomL into the second sub-divided pixel electrodes 260. A gate electrode of the third scan TFT 222 is connected to the (k+1)th gate line Gₖ₊₁ and a source electrode of the third scan TFT 222 is connected to the second sub-divided pixel electrodes 260. The drain electrode of the third scan TFT 222 is connected to the common voltage line VcomL. That is, the second sub-divided pixel 220 displays the black image, not the 3D image because the second sub-divided pixel 220 charges the common voltage in response to a gate pulse on an adjacent gate line that is positioned after the gate line Gₖ. The common voltage is charged responsive to the jₜₕ data line being charged with data voltage in response to the kₜₕ gate pulse from the kₜₕ gate line Gₖ.

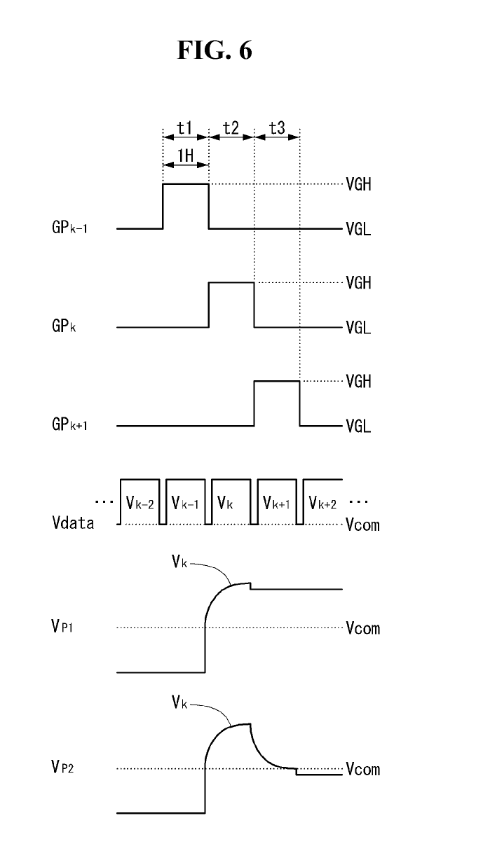

FIG. 6 illustrates a waveform diagram of gate pulses (e.g., GPₖ₋₁, GPₖ, and GPₖ₊₁), data voltages (e.g., Vₖ₋₂, Vₖ₋₁, Vₖ, Vₖ₊₁, Vₖ₊₂) a voltage V_{P1} of a first sub-divided pixel electrode, and a voltage V_{P2} of a second sub-divided pixel electrode in a 3D mode of the stereoscopic image display device. In FIG. 6, the gate driver 110 generates gate pulses having a gate high voltage VGH for a predetermined period in the 3D mode. Otherwise the gate pulses have a low gate voltage VGL. A predetermined period may be one horizontal period 1H. One horizontal period 1H describes one line scanning period in which digital video data is written to pixels in one horizontal line defined by crossing of the data lines D and the gate lines G of the display panel 10. In one embodiment, the gate high voltage VGH is a higher voltage than the gate low voltage VGL. In the 3D mode, the gate driver 110 sequentially supplies the gate pulses to a first gate line G to nth gate lines in a first direction (i.e., a forward direction) associated with an ascending order of the gate lines G. In order to simplify the description, FIG. 6 shows that the gate driver 110 sequentially supplies a (k−1)th gate pulse GPₖ₋₁ to a first gate line Gₖ₋₁, a kth gate pulse GPₖ to a second gate line Gₖ, and a (k+1)th gate pulse GPₖ₊₁ to a third gate line Gₖ₊₁ in the forward direction.

In the 3D mode, the frame memory 150 supplies the digital video data RGB to the data driver 120 in the order in which the digital video data RGB is input into the frame memory 150. The digital video data RGB supplied to a data line for a frame period includes first to nth digital video data. In the 3D mode, the frame memory 150 sequentially supplies the first digital video data to the nth digital video data to the data driver 120 in the forward direction. The data driver 120 converts the first digital video data to the nth digital video data from the frame memory 150 into first to nth analog data voltages that are representative of the digital video data.

In the 3D mode, the data converter 120 sequentially supplies the first to nth analog data voltages to the data line in the first direction (i.e., a forward direction) associated with an ascending order of the data lines. In order to simplify the description, FIG. 6 shows only that the data driver 120 sequentially supplies a (k−2)th data voltage Vₖ₋₂ to a first data line Dⱼ₋₂, a (k−1)th data voltage Vₖ₋₁ to a second data line Dⱼ₋₁, a kth data voltage Vₖ to a third data line Dⱼ, a (k+1)th data voltage Vₖ₊₁ to a fourth data line Dⱼ₊₁, and a (k+2)th data voltage Vₖ₊₂ to a fifth data line Dⱼ₊₂ in the first direction. As shown in FIG. 6, the (k−1)th data voltage Vₖ₋₁ is synchronized with the (k−1)th gate pulse GPₖ₋₁ during the time period t1 and the kth data voltage Vₖ is synchronized with the kth gate pulse GPₖ during time period t2 and the (k+1)th data voltage Vₖ₊₁ is synchronized with the (k+1)th gate pulse GPk+1 during the time period t3.

Additionally, FIG. 6 illustrates an example showing that the data driver 120 supplies to the data line for a frame period positive analog data voltages that are higher than the common voltage. Alternatively, the data driver 120 may supply positive and negative analog data voltages for each p frame period(s), wherein p is a natural number. Also, the data driver 120 may alternately supply positive and negative analog data voltages for each q horizontal period, wherein q is a natural number.

Referring to FIGS. 5, 6, and 7, the display image of the first sub-divided pixel 210 and the display image of the second sub-divided pixel 220 in 3D mode will be described below. The embodiment is implemented as a normally black mode. In the black mode, a white gray scale is represented if a voltage difference between 1) the first sub-divided pixel electrode 240 and the common electrode 250 or 2) a voltage difference between the second sub-divided pixel electrode 260 and the common electrode 250 is greater than or equal to a threshold value. In one embodiment, a black gray scale is represented if the voltage difference is less than the threshold value.

As shown in FIG. 6, a first period t1 is a period when the (k−1)th gate pulse GPₖ₋₁ is generated as the gate high voltage VGH. The first scan TFT 211, the second scan TFT 221, and the third scan TFT 222 are off for the first period t1 as represented by the zero voltage of both the voltage Vp1 of the first sub-divided pixel electrode 240 and the voltage Vp2 of the second sub-divided pixel electrode 260 during period t1.

A second period t2 is a period when the kth gate pulse GPₖ is generated as the gate high voltage VGH. The first scan TFT 211 and the second scan TFT 221 are turned on and the third scan TFT 222 is not turned on for the second period t2.

During the second period t2, the first scan TFT 211 supplies the kth data voltage Vₖ from the jth data line Dⱼ to the first sub-divided pixel electrode 240 in response to the kth gate pulse GPₖ from the kth gate line Gₖ. Thus, a voltage Vp1 of the first sub-divided pixel electrode 240 rises to the kth data voltage Vₖ during time period t2. That is, the first sub-divided pixel electrode 210 represents the white gray scale because the voltage difference between the first sub-divided pixel electrode 240 and the common electrode 250 is greater than or equal to the threshold value.

The second scan TFT 221 supplies the kth data voltage Vₖ from the jth data line Dⱼ to the second sub-divided pixel electrode 260 in response to the kth gate pulse GPₖ from the kth gate line Gₖ. Thus, a voltage Vp2 of the second sub-divided pixel electrode 260 rises to the kth data voltage Vₖ during time period t2 which is greater than the common voltage Vcom. That is, the second sub-divided pixel 220 represents the white gray scale because the voltage difference between the second sub-divided pixel electrode 260 and the common electrode 250 is greater than or equal to the threshold value.

A third period t3 is a period when the (k+1)th gate pulse is generated as the gate high voltage VGH. The first scan TFT 211 and the second scan TFT 221 are turned off and the third scan TFT 222 is turned on for the third period t3.

The third scan TFT 222 supplies the common voltage Vcom from the jth data line Dⱼ to the second sub-divided pixel electrode 260 in response to the (k+1)th gate pulse GPₖ₊₁ from the (k+1)th gate line Gₖ. Thus, a voltage Vp2 of the second sub-divided pixel electrode 260 drops to the common voltage Vcom. That is, the second sub-divided pixel 220 represents the black gray scale because the voltage difference between the second sub-divided pixel electrode 260 and the common electrode 250 is less than the threshold value. As a result, the second sub-divided pixel 220 functions as a black stripe.

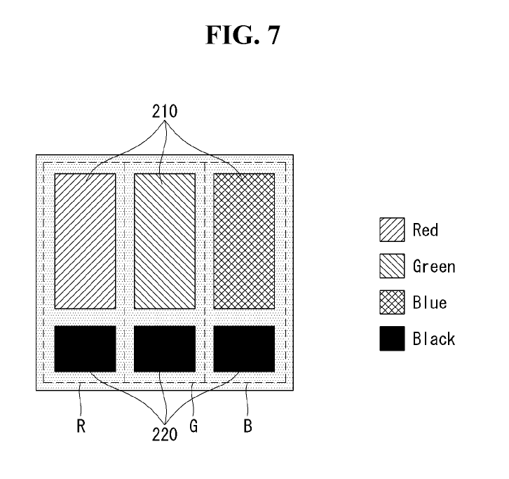

FIG. 7 illustrates a display image of a pixel in a 3D mode. In the 3D mode, a first sub-divided pixel 210 in a red sub pixel R displays a red image, a first sub-divided pixel 210 in a green sub pixel G displays a green image, and a first sub-divided pixel 210 in a blue sub pixel B displays a blue image. Also, a second sub-divided pixel 220 of the red sub pixel R, the green sub pixel G, and the blue sub pixel B all display a black image during the 3D mode. Therefore, the second sub-divided pixel 220 of the red sub pixel R, the second sub-divided pixel 220 of the green sub pixel G, the second sub-divided pixel 220 of the green sub pixel G functions as the black stripe in the 3D mode.

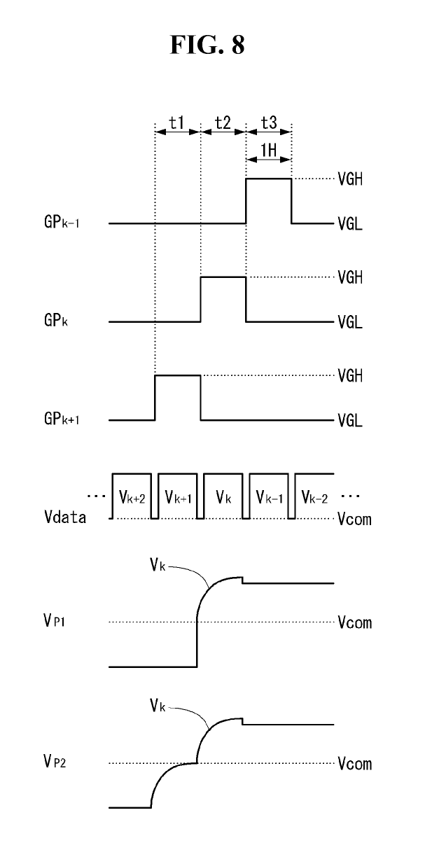

FIG. 8 illustrates a waveform diagram of gate pulses (e.g., GPₖ₋₁, GPₖ, and GPₖ₊₁), data voltages (e.g., Vₖ₊₂, Vₖ₊₁, Vₖ, Vₖ₋₁, Vₖ₋₂), a voltage Vp1 of a first sub-divided pixel electrode, and a voltage Vp2 of a second sub-divided pixel electrode in a 2D mode of the stereoscopic image display device. In FIG. 8, the gate driver 110 generates gate pulses having a gate high voltage VGH for a predetermined period in the 2D mode. Otherwise the gate pulses have a low gate voltage VGL. A predetermined period may be one horizontal period 1H. In the 2D mode, the gate driver 110 sequentially supplies the gate pulses to a first gate line to nth gate lines G in a second direction (i.e., a backward direction) associated with a descending order of the gate lines. In order to simplify the description, FIG. 8 shows only that the gate driver 110 sequentially supplies a (k+1)th gate pulse GPₖ₊₁, a kth gate pulse GPₖ, and a (k−1)th gate pulse GPₖ₋₁ in the second direction.

In the 2D mode, the frame memory 150 supplies the digital video data RGB to the data driver 120 in a reverse order in which the digital video data RGB is input into the frame memory 150. The digital video data RGB supplied to a data line D for a frame period includes a first digital video data to nth digital video data. In the 2D mode, the frame memory 150 sequentially supplies the first digital video data to the nth digital video data to the data driver 120 in the second direction. As previously mentioned, the second direction describes a reverse order in which the digital video data RGB is input into the frame memory 150. The data driver 120 converts the first digital video data to nth digital video data from the frame memory 150 into a first analog data voltage to a nth analog data voltages. The data converter 120 sequentially supplies the first analog data voltage to the nth analog data voltages to the data line in the second direction. In order to simplify the description, FIG. 8 shows only that the data driver 120 sequentially supplies a (k+2)th data voltage Vₖ₊₂, a (k+1)th data voltage Vₖ₊₁, a kth data voltage Vₖ, a (k−1)th data voltage Vₖ₋₁, and a (k−2)th data voltage Vₖ₋₂ to a jth data line in the second direction. As shown in FIG. 8, the (k+1)th data voltage Vₖ₊₁ is synchronized with the (k+1)th gate pulse GPₖ₊₁ during the period t1 and the kth data voltage Vₖ is synchronized with the kth gate pulse GPₖ during time period t2 and the (k−1)th data voltage is synchronized with the (k−1)th gate pulse GPₖ₋₁ during time period t3.

Additionally FIG. 8 illustrates an example showing that the data driver 120 supplies to the data line for a frame period positive analog data voltages that are higher than the common voltage. Alternatively, the data driver 120 may supply positive and negative analog data voltages for each p frame period(s). Also, the data driver 120 may alternately supply positive and negative analog data voltages for each q horizontal period.

Referring to FIGS. 5, 8, and 9, the display image of the first sub-divided pixel 210 and the display image of the second sub-divided pixel 220 in 2D mode will be described below. The embodiment is implemented as a normally black mode. Similar to the 3D mode, in the normally black mode, a white gray scale is represented if a voltage difference between 1) the first sub-divided pixel electrode 240 and the common electrode 250 or 2) a voltage difference between the second sub-divided pixel electrode 260 and the common electrode 250 is greater than or equal to a threshold value. In one embodiment a black gray scale is represented if the voltage difference is less than the threshold value.

A first period t1 is a period when the (k+1)th gate pulse is generated as the gate high voltage VGH and the other gate pulses are the low gate voltage VGL. During the first period t1, the first scan TFT 211 and the second scan TFT 221 are off and the third scan TFT 222 is turned on for the third period t3.

The third scan TFT 222 supplies the common voltage VcomL from the jth data line Dⱼ to the second sub-divided pixel electrode 260 in response to the (k+1)th gate pulse GPₖ₊₁ from the (k+1)th gate line Gₖ. Thus, a voltage Vp2 of the second sub-divided pixel electrode 260 rises to the common voltage Vcom during first period t1. That is, the second sub-divided pixel 220 represents the black gray scale because the voltage difference between the second sub-divided pixel electrode 260 and the common electrode 250 is less than the threshold value.

A second period t2 is a period when the kth gate pulse is generated as the gate high voltage VGH and the other gate pulses are the low gate voltage VGL. The first scan TFT 211 and the second scan TFT 221 are turned on during the second period t2 and the third scan TFT 222 is off during the second period t2.

During the second period t2, the first scan TFT 211 supplies the kth data voltage Vₖ from the jth data line Dⱼ to the first sub-divided pixel electrode 240 in response to the kth gate pulse GPₖ from the kth gate line Gₖ. Thus, a voltage Vp1 of the first sub-divided pixel electrode 240 rises to the kth data voltage Vk which is greater than the common voltage Vcom. During the second period t2, the first sub-divided pixel electrode 210 represents the white gray scale because the voltage difference between the first sub-divided pixel electrode 240 and the common electrode 250 is greater than or equal to the threshold value.

During the second time period t2, the second scan TFT 221 supplies the kth data voltage Vₖ from the jth data line Dⱼ to the second sub-divided pixel electrode 260 in response to the kth gate pulse GPₖ from the kth gate line Gₖ. Thus, a voltage Vp2 of the second sub-divided pixel electrode 260 rises to the kth data voltage Vₖ during the second time period t2. That is, the second sub-divided pixel 220 represents the white gray scale because the voltage difference between the second sub-divided pixel electrode 260 and the common electrode 250 is greater than or equal to the threshold value.

A third period t3 describes a period when the (k−1)th gate pulse is generated as the gate high voltage VGH and the other gate pulses are generated as the low gate voltage VGL. The first scan TFT 211, the second scan TFT 221, and the third scan TFT 222 are off for the third period t3.

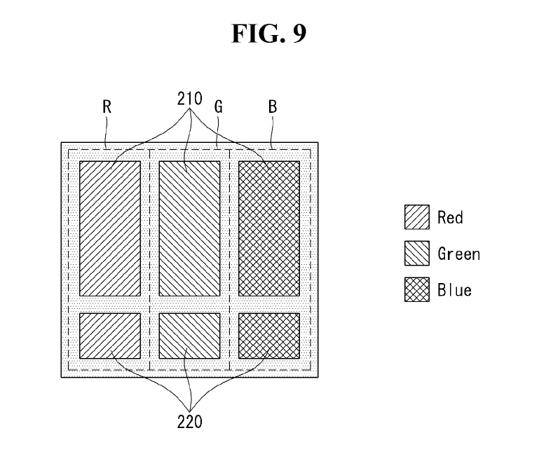

FIG. 9 illustrates a display image of a pixel in a 2D mode. In the 2D mode, a first sub-divided pixel 210 and a second sub-divided pixel 220 of a red sub pixel R displays a red image. Similarly, a first sub-divided pixel 210 and a second sub-divided pixel 220 of a green sub pixel G displays a green image and a first sub-divided pixel 210 and a second sub-divided pixel 220 of a blue sub pixel B displays a blue image. That is, the first sub-divided pixel 210 and the second sub-divided pixel 220 of the red sub pixel R, the green sub pixel G, blue sub pixel B displays an image. Thus, the embodiment shown in FIG. 9 increases a luminance of a 2D image since a black stripe is not displayed.

In one embodiment, the third scan TFT 222 is controlled by the (k+1)th gate line. Alternatively, the third scan TFT 222 is controlled by one of (k+2)th to (k+s)th gate lines, wherein s is a natural number which is greater than or equal to 3.

As described above, the embodiments described herein control a first sub-divided pixel through a kth gate line, and controls a second sub-divided pixel through the kth gate line and one of (k+2)th to (k+s)th gate lines. Also, the embodiments herein supply gate pulses in a first direction during the 3D mode and supplies gate pulses in a second direction during the 2D mode. As a result, the first sub-divided pixel and the second sub-divided pixel displays a 2D image in a 2D mode and the first sub-divided pixel displays a 3D image in a 3D mode and the second sub-divided pixel displays a black image in the 3D mode. Therefore, the embodiments herein control the second sub-divided pixels as an active black stripe although though a frequency of a gate driver is not increased. Thus, the embodiments herein decrease a cost of the gate driver.

Although the embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A stereoscopic image display device comprising:
a display panel including scan lines, data lines, and a plurality of sub pixels;
a data driver converting the digital video data into data voltages and supplying the data voltages to the data lines; and
a gate driver sequentially supplying gate pulses synchronized with the data voltages to the gate lines,
wherein each of the sub pixels includes:
a first sub-divided pixel that charges the data voltage from a jth data line into a first sub-divided pixel electrode in response to a kth gate pulse from a kth gate line, wherein j is a natural number equal to or more than 1 and equal to or less than m, and m is a number of the data lines of the display panel, and k is a natural number equal to or more than 1 and equal to or less than n, and n is a number of the gate lines of the display panel; and
a second sub-divided pixel that charges the data voltage from the jth data line into a second sub-divided pixel electrode in response to the kth gate pulse and charges a common voltage from a common voltage line into the second sub-divided pixel electrode in response to a gate pulse from one of (k+1) to (k+s) gate lines wherein s is a natural number equal to or more than 3.

2. The stereoscopic image display device of claim 1, wherein the gate driver supplies the gate pulses to first to nth gate lines in a forward direction in a 3D mode and supplies the gate pulses into the first to nth gate lines in a backward direction in a 2D mode.

3. The stereoscopic image display device of claim 2, further comprising:
a frame memory that stores the digital video data and in the 3D mode supplies the digital video data to the data driver in order in which the digital video data is input and in the 2D mode supplies the digital video data to the data driver in reverse order in which the digital video data is input.

4. The stereoscopic image display device of claim 3, wherein the data driver supplies sequentially first to nth data voltages to each of the data lines in the forward direction in the 3D mode and supplies sequentially the first to nth data voltages to the each of the data lines in the backward direction in the 2D mode.

5. The stereoscopic image display device of claim 1, wherein the first sub-divided pixel includes a first scan thin film transistor (TFT) having comprising a gate electrode connected to the kth gate line, a source electrode connected to the jth data line, and a drain electrode connected to the first sub-divided pixel electrode.

6. The stereoscopic image display device of claim 1, wherein the second sub-divided pixel includes:
a second scan TFT having a gate electrode connected to the kth gate line, a source electrode connected to the jth data line, and a drain electrode connected to the second sub-divided pixel electrode; and
a third scan TFT having a gate electrode connected to the (k+1)th gate line, a source electrode connected to the second sub-divided pixel electrode, and a drain electrode connected to the common electrode.

7. A method for driving a stereoscopic image display device comprising a display panel including scan lines, data lines, and a plurality of sub pixels comprising:
(a) converting the digital video data into data voltages and supplying the data voltages to the data lines;
(b) sequentially supplying gate pulses synchronized with the data voltages to the gate lines;
(c) a first sub-divided pixel charging the data voltage from a jth data line to a first sub-divided pixel electrode in response to a kth gate pulse from a kth gate line, wherein j is a natural number equal to or more than 1 and equal to or less than m, and m is a number of the data lines of the display panel, and k is a natural number equal to or more than 1 and equal to or less than n, and n is a number of the gate lines of the display panel; and
(d) a second sub-divided pixel charging the data voltage from the jth data line to a second sub-divided pixel electrode in response to the kth gate pulse and charges a common voltage from a common voltage line to the second sub-divided pixel electrode in response to a gate pulse from one of (k+1) to (k+s) gate lines wherein s is a natural number equal to or more than 3.

8. The method for driving the stereoscopic image display device of claim 7, wherein the step (b) includes supplying the gate pulses to first to nth gate lines in a forward direction in a 3D mode and supplying the gate pulses into the first to nth gate lines in a backward direction in a 2D mode.

9. The method for driving the stereoscopic image display device of claim 8, wherein the step (a) includes storing the digital video data, and supplying the digital video data to the data driver in order in which the digital video data is input in the 3D mode, and supplying the digital video data to the data driver in reverse order in which the digital video data is input in the 2D mode.

10. The method for driving the stereoscopic image display device of claim 9, wherein the step (a) includes supplying sequentially first to nth data voltages to each of the data lines in the forward direction in the 3D mode and supplies sequentially the first to nth data voltages to the each of the data lines in the backward direction in the 2D mode.

11. A stereoscopic image display device comprising:
a display panel including scan lines, data lines crossing the scan lines, and pixels, wherein each pixel is divided into a first sub-divided pixel and a second sub-divided pixel to form first sub-divided pixels and second sub-divided pixels;
wherein a first sub-divided pixel of a pixel charges a data voltage from a data line coupled to the pixel into a first sub-divided pixel electrode of the pixel responsive to a gate pulse from a gate line coupled to the pixel; and
wherein a second sub-divided pixel of the pixel charges data voltage from the data line into a second sub-divided pixel electrode of the pixel responsive to the gate pulse from the gate line and wherein the second sub-divided pixel charges a common voltage from a common voltage line into the second sub-divided pixel electrode responsive to a gate pulse from another gate line.

12. The stereoscopic image display device of claim 11, further comprising a gate driver that supplies gate pulses to a plurality of gate lines in a first order of the plurality of gate lines in a 3D mode of the stereoscopic image display device and supplies the gate pulses to the plurality of gate lines in a second order of the plurality of gate lines in a 2D mode of the stereoscopic image display device.

13. The stereoscopic image display device of claim 12, wherein the first order comprises an ascending order of the plurality of gate lines and the second order comprises a descending order of the plurality of gate lines.

14. The stereoscopic image display device of claim 12, further comprising:
a frame memory that stores digital video data in an order in which the digital video data are inputted into the frame memory;
wherein the frame memory supplies the digital video data to a data driver in the order in which the digital video data is input into the frame memory in the 3D mode of the stereoscopic image display device; and
wherein the frame memory supplies the digital video data to the data driver in a reverse order of the order in which the digital video data is input into the frame memory in the 3D mode of the stereoscopic image display device.

15. The stereoscopic image display device of claim 14, wherein the data driver sequentially supplies data voltages that are representative of the digital video data to the data lines in a first order of the data lines in the 3D mode of the stereoscopic image display device and the data driver sequentially supplies the data voltages to the data lines in a second order of the data lines in the 2D mode of the stereoscopic image display device.

16. The stereoscopic image display device of claim 15, wherein the first order comprises an ascending order of the data lines and the second order comprises a descending order of the data lines.

17. The stereoscopic image display device of claim 11, wherein the first sub-divided pixel includes a first scan thin film transistor (TFT) comprising a gate electrode connected to the gate line, a source electrode connected to data line, and a drain electrode connected to the first sub-divided pixel electrode.

18. The stereoscopic image display device of claim 11, wherein the second sub-divided pixel includes:
a second scan TFT comprising a gate electrode connected to the gate line, a source electrode connected to the data line, and a drain electrode connected to the second sub-divided pixel electrode; and
a third scan TFT comprising a gate electrode connected to the another gate line, a source electrode connected to the second sub-divided pixel electrode, and a drain electrode connected to the common electrode.

19. A method for driving a stereoscopic image display device comprising a display panel including scan lines, data lines crossing the scan lines, and pixels, wherein each pixel is divided into a first sub-divided pixel and a second sub-divided pixel to form first sub-divided pixels and second sub-divided pixels, the method comprising:
converting digital video data into data voltages;
supplying the data voltages to the data lines;
sequentially supplying gate pulses synchronized with the data voltages to the gate lines;
charging a first sub-divided pixel of a pixel with a data voltage from a data line that is coupled to the pixel to a first sub-divided pixel electrode of the pixel responsive to a gate pulse from a gate line coupled to the pixel;
charging a second sub-divided pixel of the pixel with the data voltage from the data line to a second sub-divided pixel electrode of the pixel responsive to the gate pulse from the gate line; and
charging a common voltage from a common voltage line to the second sub-divided pixel electrode responsive to a gate pulse from another gate line.

20. The method for driving the stereoscopic image display device of claim 19, wherein sequentially supplying the gate pulses comprises:
supplying the gate pulses to a plurality of gate lines in a first order of the plurality of gate lines in a 3D mode of the stereoscopic image display device; and
supplying the gate pulses to the plurality of gate lines in a second order of the plurality of gate lines in a 2D mode of the stereoscopic image display device.

21. The method for driving the stereoscopic image display device of claim 20, wherein the first order comprises an ascending order of the plurality of gate lines and the second order comprises a descending order of the plurality of gate lines.

22. The method for driving the stereoscopic image display device of claim 19, wherein supplying the data voltages to the data lines comprises:
storing the data voltages in a frame memory in an order in which the data voltages are inputted into the frame memory;
supplying the data voltages to a data driver in the order in which the data voltages are inputted into the frame memory in the 3D mode of the stereoscopic image display device; and
supplying the data voltages to the data driver in a reverse order of the order in which the data voltages are inputted into the frame memory in the 2D mode of the stereoscopic image display device.

23. The method for driving the stereoscopic image display device of claim 22, wherein supplying the data voltages to the data lines comprises:
sequentially supplying the data voltages to the data lines in a first order of the data lines in the 3D mode of the stereoscopic image display device; and
sequentially supplying the data voltages to the data lines in a second order of the data lines in the 2D mode of the stereoscopic image display device.

24. The method for driving the stereoscopic image display device of claim 23, wherein the first order comprises an ascending order of the data lines and the second order comprises a descending order of the data lines.
